(19) United States
(12) Patent Application Publication
(10) Pub. No.: US 2011/0115835 A1
(43) Pub. Date: May 19, 2011

(54) PIXEL CIRCUIT AND ORGANIC LIGHT- EMITTING DIODE DISPLAY USING THE PIXEL CIRCUIT

(75) Inventor: Wook LEE, Yongin-city (KR)

(73) Assignee: Samsung Mobile Display Co., Ltd., Yongin-city (KR)

(21) Appl. No.: 12/843,170

(22) Filed: Jul. 26, 2010

(30) Foreign Application Priority Data
Nov. 18, 2009 (KR) 10-2009-0111537

(51) Int. Cl. G09G 3/30; G09G 5/10; G09G 5/00

(52) U.S. Cl. 345/691; 345/214; 345/77

(57) ABSTRACT

A pixel circuit and an organic light emitting diode (OLED) display including the pixel circuit. The pixel circuit includes an organic light emitting diode OLED having an anode; a storage capacitor having a terminal connected to a first electric power and another terminal connected to a first node; a third transistor having a gate connected to a first scan line, a first electrode connected to the first node, and a second electrode connected to the anode of the OLED; a second transistor having a gate connected to the first scan line, a first electrode connected to a data line, and a second electrode connected to a second node; a fourth transistor having a gate connected to a light emission control line, a first electrode connected to the first electric power, and a second electrode connected to the second node; and a first transistor having a gate connected to the first node, a first electrode connected to the second node, and a second electrode connected to the anode of the OLED. A voltage at the first node is adjusted by controlling a pulse width of a first scan signal provided from the first scan line in order to control a current supplied to the OLED.

### CROSS-REFERENCE TO RELATED APPLICATION

This application claims the benefit of Korean Patent Application No. 10-2009-0111537, filed Nov. 18, 2009 in the Korean Intellectual Property Office, the disclosure of which is incorporated herein by reference.

### BACKGROUND

1. Field

Aspects of the present invention relate to a pixel circuit and an organic light emitting diode (OLED) display using the pixel circuit.

2. Description of the Related Art

Flat panel displays include liquid crystal displays (LCDs), plasma display panels (PDPs), and field emission displays (FEDs). Flat panel displays address the disadvantages of cathode ray tubes (CRTs). Among the flat panel displays, organic light-emitting diode (OLED) displays have been considered next generation displays and have excellent performance in view of light emitting efficiency, brightness, and viewing angles, and fast response speeds.

The OLED displays display images using OLEDs. OLEDs generate light due to the recombination of electrons and holes. The OLED displays have fast response speeds, and are driven with low power consumption. In general, OLED displays, and in particular, active matrix OLED (AMOLED) displays, use an automatic current limit (ACL) function that adjusts power consumption of the AMOLED displays by adjusting a light emission time of the OLED to reduce the power consumption of a display panel.

### SUMMARY

Aspects of the present invention provide a pixel circuit, which may realize an automatic current limit (ACL) function regardless of a structure of a display panel and may emit light in a pixel unit, not a frame unit, by limiting current supplied to an organic light emitting diode (OLED) through a timing control of a scan signal, and an OLED display including the pixel circuit.

According to an aspect of the present invention, there is provided a pixel circuit including: an organic light emitting diode (OLED) having an anode; a storage capacitor having a terminal connected to a first electric power and another terminal connected to a first node; a third transistor having a gate connected to a first scan line, a first electrode connected to the first node, and a second electrode connected to the anode of the OLED; a second transistor having a gate connected to the first scan line, a first electrode connected to a data line, and a second electrode connected to a second node; a fourth transistor having a gate connected to a light emission control line, a first electrode connected to the first electric power, and a second electrode connected to the second node; and a first transistor having a gate connected to the first node, a first electrode connected to the second node, and a second electrode connected to the anode of the OLED, wherein a voltage at the first node is adjusted by controlling a pulse width of a first scan signal provided from the first scan line in order to control a current supplied to the OLED.

According to an aspect of the invention, the second transistor may transfer a data signal from the data line to the second node in response to the first scan signal.

According to an aspect of the invention, the third transistor may perform a diode-connection of the first transistor in response to the first scan signal from the first scan line.

According to an aspect of the invention, the fourth transistor may transfer a voltage of the first electric power to the second node in response to a light emission control signal from the light emission control line.

According to an aspect of the invention, the pulse width of the first scan signal may be smaller than a pulse width of the light emission control signal.

According to an aspect of the invention, the pixel circuit may further include a fifth transistor having a gate and a first electrode which are commonly connected to a second scan line and a second electrode connected to the first node.

According to an aspect of the invention, the pixel circuit may further include a sixth transistor having a gate connected to the light emission control line, wherein the sixth transistor may be connected between the first transistor and the OLED.

According to an aspect of the invention, the first through sixth transistors may be p-channel metal oxide semiconductor (PMOS) transistors.

According to another aspect of the present invention, there is provided an organic light-emitting diode (OLED) display including: a first scan driving unit supplying scan signals to scan lines; a second scan driving unit supplying light emission control signals to light emission control lines; a data driving unit supplying data signals to data lines; pixel circuits disposed at corresponding intersection of the scan lines, the light emission control lines, and the data lines, the pixel circuits each comprising: an OLED having an anode, a storage capacitor having a terminal connected to a first electric power and another terminal connected to a first node, a third transistor having a gate connected to a first scan line, a first electrode connected to the first node, and a second electrode connected to the anode of the OLED, a second transistor having a gate connected to the first scan line, a first electrode connected to a data line, and a second electrode connected to a second node, a fourth transistor having a gate connected to a light emission control line, a first electrode connected to the first electric power, and a second electrode connected to the second node, and a first transistor having a gate connected to the first node, a first electrode connected to the second node, and a second electrode connected to the anode of the OLED; and a brightness control signal generator for generating a brightness control signal which controls the first scan driving unit to control light emission brightness of each of the pixel circuits.

According to an aspect of the invention, a voltage at the first node may be adjusted by controlling a pulse width of the first scan signal from the first scan line in order to control a current supplied to the OLED.

According to an aspect of the invention, the first scan driving unit may generate a scan signal having a pulse width corresponding to the brightness control signal, and may supply the generated scan signal to the scan line.

According to an aspect of the invention, the second transistor may transfer a data signal from the data line to the second node in response to the first scan signal, the third transistor may perform a diode-connection of the first transistor in response to the first scan signal from the first scan line, and the fourth transistor may transfer a voltage of the first electric power to the second node in response to a light emission control signal from the light emission control line.

According to an aspect of the invention, the pulse width of the first scan signal may be smaller than the pulse width of the light emission control signal.

According to an aspect of the invention, the organic light emitting apparatus may further include: a fifth transistor having a gate and a first electrode which are commonly connected to a second scan line and a second electrode connected to the first node; and a sixth transistor having a gate connected to the light emission control line, wherein the sixth transistor is connected between the first transistor and the OLED, wherein the fifth transistor initializes the first node in response to a second scan signal from the second scan line.

According to an aspect of the invention, the first through sixth transistors may be p-channel metal oxide semiconductor (PMOS) transistors.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual diagram of an organic light emitting diode (OLED) according to an embodiment of the present invention;

FIG. 2 is a circuit diagram of a pixel circuit representing a voltage driving method;

FIG. 3 is a diagram of an OLED display according to an embodiment of the present invention;

FIG. 4 is a circuit diagram of a pixel circuit shown in FIG. 3 according to an embodiment of the present invention;

FIG. 5 is a timing diagram of the pixel circuit shown in FIG. 4;

FIG. 6 is a circuit diagram of a pixel circuit according to an embodiment of the present invention;

FIG. 7 is a timing diagram of the pixel circuit shown in FIG. 6; and

FIGS. 8A through 8C are diagrams illustrating operations of driving the pixel circuit shown in FIG. 6.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In general, according to an organic light-emitting diode (OLED) display, fluorescent organic compounds are electrically excited to emit light. A plurality of organic light emitting cells are arranged as a matrix and are driven by a voltage or a current to display images. The plurality of organic light emitting cells are referred to as OLEDs.

FIG. 1 is a conceptual diagram of an OLED. Referring to FIG. 1, the OLED includes an anode (made of indium tin oxide (ITO) by way of example), an organic thin film, and a cathode (a metal by way of example). The organic thin film includes an emissive layer (EML), an electron transport layer (ETL), and a hole transport layer (HTL). In addition, the organic thin film may further include a hole injection layer (HIL) or an electron injection layer (EIL), as shown.

The above-described OLED is used in an OLED display that may be driven in a passive matrix type and an active matrix type using a thin-film transistor (TFT) or a metal oxide semiconductor field effect transistor (MOSFET). According to the passive matrix type, an anode and a cathode are formed to cross each other at right angles, and a line is selected to be driven. However, according to the active matrix type, a TFT is connected to an indium tin oxide (ITO) pixel electrode, and the OLED is driven by a voltage sustained by a capacitance of a capacitor that is connected to a gate of the TFT. The active matrix type includes a voltage driving method in which a voltage signal is applied to the capacitor in order to store a voltage in the capacitor to maintain the voltage.

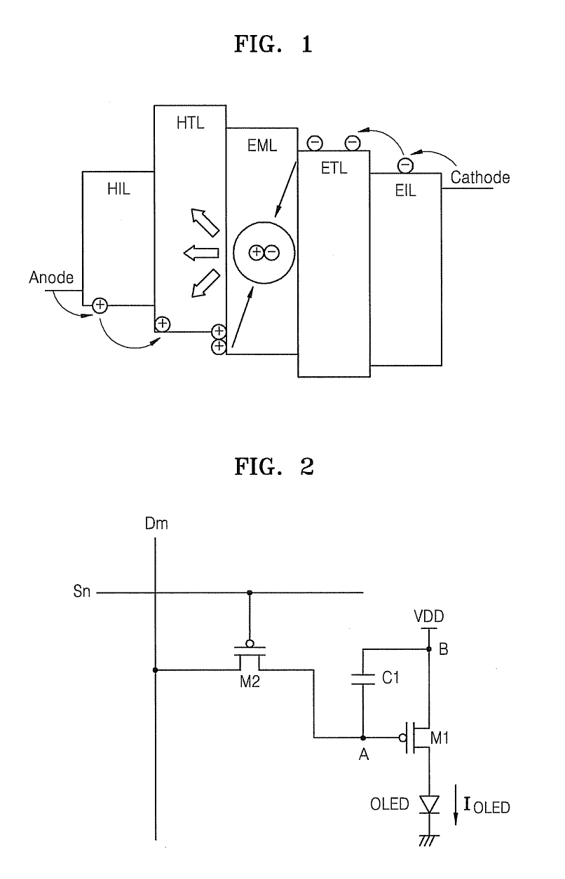

FIG. 2 is a circuit diagram of a pixel circuit representing a voltage driving method. Referring to FIG. 2, a switching transistor M2 is turned on by a selection signal applied to a selected scan line Sn. A data voltage is applied to a gate of a driving transistor M1 from a data line Dm due to the turning on of the switching transistor M2. Then, a voltage difference between the data voltage and a voltage of a voltage source VDD is stored in a capacitor C1 connected between the gate and a source of the driving transistor M1. A driving current I_{OLED} flows in an OLED due to the voltage difference, and thus, the OLED emits light. Predetermined contrast gray levels may be displayed according to a level of the applied data voltage.

In general, an active matrix OLED (AMOLED) display uses an automatic current limit (ACL) function, which adjusts the power consumption of the AMOLED display, by adjusting a light-emitting time of an OLED, in order to reduce the power consumption of the AMOLED display. That is, a display driver integrated circuit (IC) generates pulses that may adjust the light-emitting time according to the image display data and applies the generated pulses to the AMOLED display. The AMOLED display shifts the pulses to each of the lines (shift register) to realize the ACL function. The AMOLED display requires a shift register logic in order to propagate the pulses for adjusting the light-emitting time, and the shift register logic may be realized as a complementary metal oxide semiconductor (CMOS) type panel. However, a p-channel metal oxide semiconductor (PMOS) panel has been used recently because the PMOS panel is more advantageous than the CMOS panel in view of the reduction of processing time and fabrication costs. If the PMOS panel is used, it is complex to realize the shift register logic for executing the ACL function, and power consumption rapidly increases in a section in which a switch is turned on due to the characteristics of a PMOS transistor. Accordingly, it is near impossible to support the ACL function using the PMOS transistor. In addition, a self-emissive device such as the AMOLED display should include the ACL function for reducing an instant peak current.

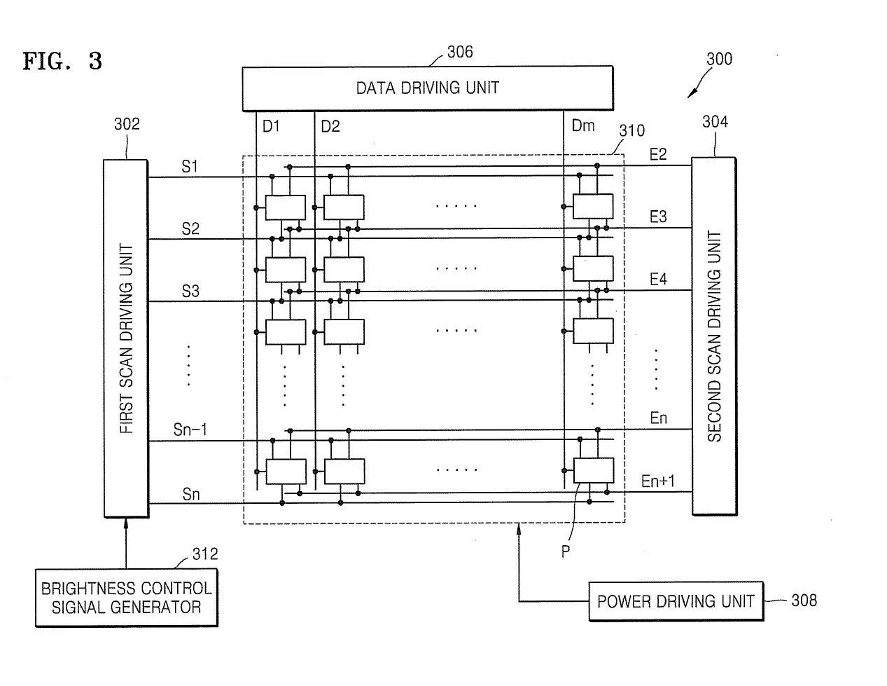

FIG. 3 is a diagram of an OLED display 300 according to an embodiment of the present invention. Referring to FIG. 3, the OLED display 300 includes a pixel array 310, a first scan driving unit 302, a second scan driving unit 304, a data driving unit 306, an electric power driving unit 308, and a brightness control signal generator 312.

The pixel array 310 includes n×m pixel circuits P. Each pixel circuit P includes an OLED. The pixel array 10 includes n scan lines S1, S2, . . . , Sn arranged in a row direction to transfer scan signals, m data lines D1, D2, . . . , Dm arranged in a column direction to transfer data signals, n light emission control lines E2, E3, . . . , En+1 arranged in the row direction to transfer light emission control signals, and m first power lines (not shown) and m second power lines (not shown) for applying first and second electric power ELVDD and ELVSS. n and m are natural numbers. The pixel array 310 makes the OLED (not shown) emit light by using the scan signal, the data signal, the light emission control signal, and the first electric power ELVDD and the second electric power ELVSS to display images.

The first scan driving unit 302 is connected to the scan lines S1, S2, . . . , Sn to apply the scan signals to the pixel array 310. Here, the first scan driving unit 302 adjusts a pulse width of a scan signal according to a brightness control signal supplied from the brightness control signal generator 312.

The second scan driving unit 304 is connected to the light emission control lines E2, E3, . . . , En+1 to apply the light emission control signals to the pixel array 310.

The data driving unit 306 is connected to the data lines D1, D2, . . . , Dm to apply the data signals to the pixel array 310. Here, the data driving unit 306 supplies the data signals to a pair of pixel circuits P of the pixel array 310 during programming.

The electric power driving unit 308 applies the first electric power ELVDD and the second electric power ELVSS to each of the pixel circuits P of the pixel array 310.

The brightness control signal generator 312 generates the brightness control signals and supplies the brightness control signals to the first scan driving unit 302. Here, when there is a need to limit the current amount supplied to the OLED, the brightness control signal generator 312 generates a brightness control signal and transmits the generated brightness control signal to the first scan driving unit 302. For example, when an optical sensor (not shown) for sensing peripheral brightness senses that the peripheral light is bright, the brightness control signal generator 312 generates a brightness control signal for limiting an instant peak current that may be sensed by a current sensor (not shown) of the OLED.

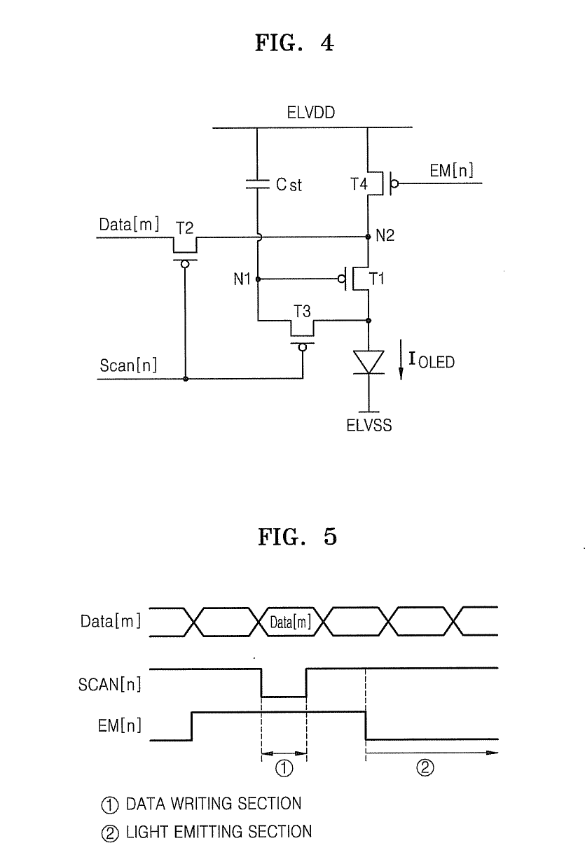

FIG. 4 is a circuit diagram of a pixel circuit according to the embodiment of the present invention. In FIG. 4, the pixel circuit is connected to an N-th scan line S[n], an N-th light emission control line EM[n], and an M-th data line D[m] is shown for the convenience of description. An anode of the OLED (not shown) is connected to a second electrode of a third transistor T3. A cathode of the OLED (not shown) is connected to the second electric power ELVSS. The OLED generates light of a predetermined brightness corresponding to the amount of current supplied from the first transistor T1 (that is, the driving transistor).

A terminal of the storage capacitor Cst is connected to the first electric power ELVDD and the other terminal of the storage capacitor Cst is connected to a first node N1. The storage capacitor Cst charges a voltage at the first node N1 during a data writing section.

A gate of the third transistor T3 is connected to the N-th scan line S[n]. A first electrode of the third transistor T3 is connected to the first node N1. The second electrode of the third transistor T3 is connected to the anode of the OLED (not shown). When a first scan signal (that is, a signal of low level) is applied from the N-th scan line S[n] to the gate of the third transistor T3, the third transistor T3 is turned on to connect a gate and a source of the first transistor T1.

The gate of the first transistor T1 is connected to the first node N1. A first electrode (drain) of the first transistor T1 is connected to the second node N2. A second electrode (source) of the first transistor T1 is connected to the anode of the OLED (not shown). The current flowing to the OLED is determined by a voltage difference between voltages of the gate and the source of the first transistor T1.

A gate of the second transistor T2 is connected to the N-th scan line S[n]. A first electrode is connected to the data line D[m]. The second electrode is connected to the second node N2. When the first scan signal (that is, the signal of low level) is applied to the gate of the second transistor T2 from the N-th scan line S[n], the second transistor T2 is turned on to transfer the data signal to the second node N2. Here, the first and third transistors T1 and T3 are simultaneously turned on by the first scan signal. Thus, the data signal is transferred through the first and third transistors T1 and T3, and the storage capacitor Cst stores the voltage between the first electric power ELVDD and the first node N1. Here, a voltage Vc at the first node N1 may be defined by the following Equation 1.

Vc=Vi[1−e^{-t}^{_{wr}}^{/RC}] (1) (1)

Vc denotes a charged voltage of the gate in the first transistor T1 (that is, the first node N1) for a time period t_{wr}. R denotes the entire resistance on the path of the data signal, and C denotes a capacitance of the storage capacitor Cst. In particular, t_{wr} denotes the data writing time. The data writing time t_{wr} is determined by a low level pulse width of the first scan signal (that is, the first scan signal from the N-th scan line S[n]). Here, it is assumed that an initial voltage V1 is constant, and thus, the gate voltage Vc of the first transistor T1 may be controlled by adjusting the time period t_{wr}.

A gate of the fourth transistor T4 is connected to the light emission control line EM[n], a first electrode is connected to the first electric power ELVDD, and a second electrode is connected to the second node N2. The fourth transistor T4 is turned on when a light emission control signal (that is, a signal of low level), is applied from the light emission control line EM[n]. The fourth transistor T4 applies the voltage of the first electric power ELVDD to the first electrode of the first transistor T1. Since the first scan signal applied to the gates of the second and third transistors T2 and T3 is at the high level when the light emission control signal is at the low level, the second and third transistors T2 and T3 are turned off. The current I_{OLED} supplied to the OLED may be defined by the following Equation 2.

I_{OLED}=K(V_{gs}−Vₜₕ)² (2)

K denotes a constant value that is determined by a mobility and a parasitic capacitance of the driving transistor. Vgs denotes a difference between voltages of the gate and source in the driving transistor. Vth denotes a threshold voltage of the driving transistor T1. When the data writing time t_{wr} is increased (that is, when the pulse width of the first scan signal is increased) the gate voltage Vc is reduced. Accordingly, the current I_{OLED} supplied to the OLED is reduced and the brightness is lowered. In addition, when the data writing time t_{wr} is reduced (that is, the pulse width of the first scan signal is reduced), the gate voltage Vc is increased. Accordingly, the current I_{OLED} supplied to the OLED is increased and the brightness is improved. Therefore, the magnitude of the current I_{OLED} flowing to the OLED may be restricted by controlling the pulse width of the first scan signal.

In the shown embodiment, the switching transistors T2 through T4 and the driving transistor T1 are PMOS transistors. The PMOS transistor is turned on when the control signal is at the low level and turned off when the control signal is at the high level.

Operations of driving the pixel circuit of FIG. 4 will be described with reference to the timing diagram of FIG. 5. Referring to FIG. 5, in a first section (that is, the data writing section) the first scan signal is at the low level in order to store the data signal in the storage capacitor Cst. A second section is a light emitting section in which the light emission signal EM[n] is at the low level.

Switching operations and driving operations of the transistors T1 through T4 will be described in detail with reference to FIGS. 4 and 5. In the first section, when the first scan signal of the low level is applied to the second and third transistors T2 and T3, the second and third transistors T2 and T3 are turned on and the data signal is applied from the data line D[m] to the first node N1, and the voltage at the first node N1 is stored in the storage capacitor Cst.

In the second section, when the light emission control signal EM[n] of low level is applied to the fourth transistor T4, the fourth transistor T4 is turned on and the voltage of the first electric power ELVDD is applied to the first transistor T1. In addition, the current I_{OLED} supplied to the OLED is determined by Equations 1 and 2 above. Therefore, according to the pixel circuit of the present embodiment, the pulse width of the scan signal is adjusted to control the current I_{OLED} supplied to the OLED.

The switching transistor T1 applying the data signal according to the scan signal requires data writing time of a few micro seconds (μs) in a pixel unit. Thus, the problem of increasing current leakage may be prevented. In addition, the voltage charged in the storage capacitor Cst is controlled by adjusting the time, and a color shift problem that may be caused by direct change of a RGB gamma voltage may be prevented. In addition, since the ACL operation is not controlled by the on/off of the light emission time, degradation of lifespan of the organic light emitting material caused by on/off stress may be prevented.

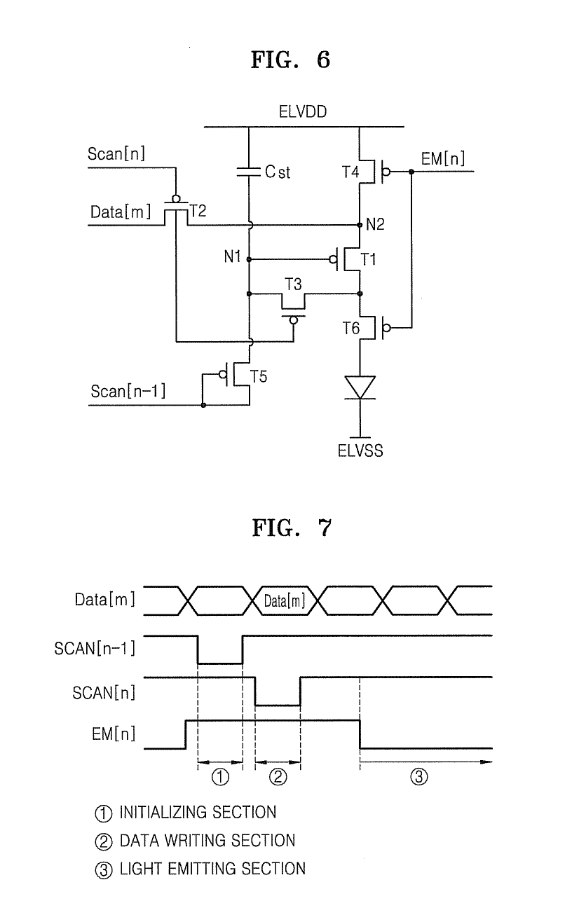

FIG. 6 is a circuit diagram of a pixel circuit according to an embodiment of the present invention. The pixel circuit of FIG. 6 is different from the pixel circuit of FIG. 4 in view of further including a fifth transistor T5 and a sixth transistor T6, and an (N−1)th scan line S[n−1]. Referring to FIG. 6, a gate and a first electrode of the fifth transistor T5 are commonly connected to the (N−1)th scan line S[n−1], and a second electrode of the fifth transistor T5 is connected to the first node N1. The fifth transistor T5 is turned on when a second scan signal (that is, a signal of low level) is applied from the (N−1)th scan line S[n−1], and initializes the first node N1. That is, the gate voltage of the first transistor T1 and the storage capacitor Cst are initialized.

A gate of the sixth transistor T6 is connected to the light emission control line EM[n], and the sixth transistor T6 is connected between the first transistor T1 and the OLED. The sixth transistor T6 is turned on when the light emission control signal (that is, the signal of low level) is applied from the light emission control line EM[n], and transfers the current output from the first transistor T1 to the OLED.

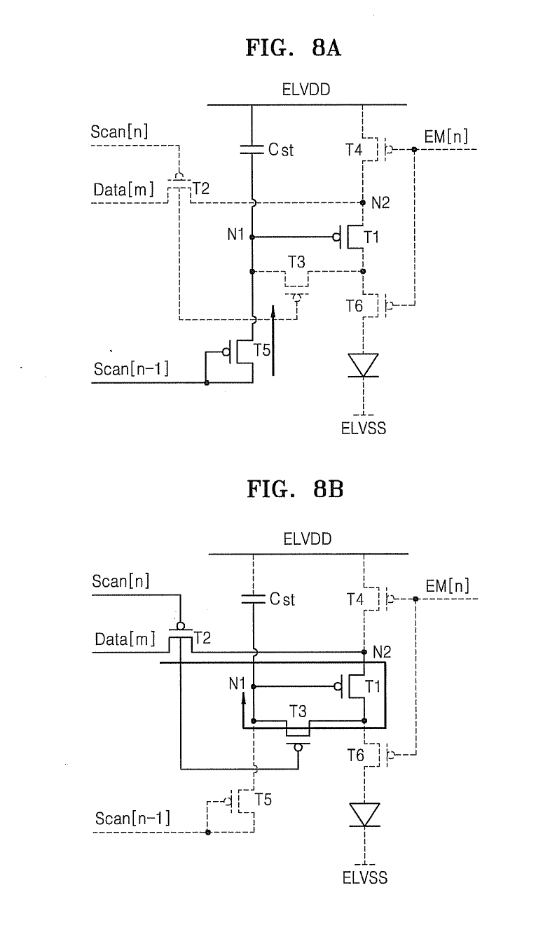

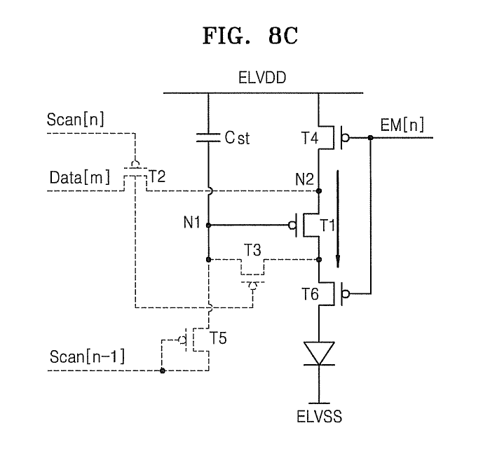

FIG. 7 is a timing diagram of the pixel circuit of FIG. 6, and FIGS. 8A through 8C are diagrams illustrating operations of driving the pixel circuit of FIG. 6. Referring to FIGS. 7 and 8A, in the first section, the second scan signal of low level is applied to the circuit, and the fifth transistor T5 is turned on to initialize the first node N1. The first scan signal and the light emission control signal are at high level, and thus, the second, third, fourth, and sixth transistors T2, T3, T4, and T6 are turned off, and the second scan signal is transferred to the first node N1.

Referring to FIGS. 7 and 8B, in the second section, when the first scan signal of low level is applied to the circuit, the second and third transistors T2 and T3 are turned on, and the data signal is transferred from the data line D[m] to the first node N1 via the second node N2, the first transistor T1, and the third transistor T3. Here, since the second scan signal and the light emission control signal are at the high level, the fourth, fifth, and sixth transistors T4, T5, and T6 are turned off, and the data signal is transferred to the first node N1. Therefore, the voltage at the first node N1 is charged to the storage capacitor Cst. The voltage Vc at the first node N1 is determined by the data writing time, that is, the pulse width of the first scan signal of low level, as expressed by Equation 1 above.

Referring to FIGS. 7 and 8C, in a third section, the light emission control signal of low level is applied to the circuit, the fourth and sixth transistors T4 and T6 are turned on and the voltage of the first electric power ELVDDD is applied to the first transistor T1. In addition, the current I_{OLED} flowing to the OLED is determined by the voltage Vc at the first node N1. As described with reference to Equations 1 and 2, the current I_{OLED} is determined according to the voltage Vc at the first node N1, and the voltage Vc is adjusted according to the pulse width of the first scan signal from scan line S[n].

The pixel circuit according to the present embodiment has been described with reference FIGS. 7 and 8A through 8C, and operations of driving the pixel circuit are the same as the pixel circuit of the previous embodiment.

According to embodiments of the present invention, the electric current transferred to the OLED may be controlled by controlling timing of scan signals, the ACL function may be realized without regard to the NMOS or PMOS, flicker phenomenon that may be generated when excessive ACL is performed may be removed, and the reduction of lifespan of the organic material due to the on/off stress of the switching transistor may be prevented.

In addition, the ACL may be performed by the pixel unit, not by the frame unit.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A pixel circuit comprising:
an organic light emitting diode (OLED) having an anode;
a storage capacitor having a terminal connected to a first electric power and another terminal connected to a first node;
a third transistor having a gate connected to a first scan line, a first electrode connected to the first node, and a second electrode connected to the anode of the OLED;
a second transistor having a gate connected to the first scan line, a first electrode connected to a data line, and a second electrode connected to a second node;
a fourth transistor having a gate connected to a light emission control line, a first electrode connected to the first electric power, and a second electrode connected to the second node; and
a first transistor having a gate connected to the first node, a first electrode connected to the second node, and a second electrode connected to the anode of the OLED,
wherein a voltage at the first node is adjusted by controlling a pulse width of a first scan signal provided from the first scan line in order to control a current supplied to the OLED.

2. The pixel circuit of claim 1, wherein the second transistor transfers a data signal from the data line to the second node in response to the first scan signal.

3. The pixel circuit of claim 1, wherein the third transistor performs a diode-connection of the first transistor in response to the first scan signal from the first scan line.

4. The pixel circuit of claim 1, wherein the fourth transistor transfers a voltage of the first electric power to the second node in response to a light emission control signal from the light emission control line.

5. The pixel circuit of claim 4, wherein the pulse width of the first scan signal is smaller than a pulse width of the light emission control signal.

6. The pixel circuit of claim 1, further comprising a fifth transistor having a gate and a first electrode which are commonly connected to a second scan line and a second electrode connected to the first node.

7. The pixel circuit of claim 6, further comprising a sixth transistor having a gate connected to the light emission control line, wherein the sixth transistor is connected between the first transistor and the OLED.

8. The pixel circuit of claim 7, wherein the first through sixth transistors are p-channel metal oxide semiconductor (PMOS) transistors.

9. An organic light-emitting diode (OLED) display comprising:
a first scan driving unit supplying scan signals to scan lines;
a second scan driving unit supplying light emission control signals to light emission control lines;
a data driving unit supplying data signals to data lines;
pixel circuits disposed at corresponding intersections of the scan lines, the light emission control lines, and the data lines, the pixel circuits each comprising:
an OLED having an anode;
a storage capacitor having a terminal connected to a first electric power and another terminal connected to a first node,
a third transistor having a gate connected to a first scan line, a first electrode connected to the first node, and a second electrode connected to the anode of the OLED,
a second transistor having a gate connected to the first scan line, a first electrode connected to a data line, and a second electrode connected to a second node,
a fourth transistor having a gate connected to a light emission control line, a first electrode connected to the first electric power, and a second electrode connected to the second node, and
a first transistor having a gate connected to the first node, a first electrode connected to the second node, and a second electrode connected to the anode of the OLED; and
a brightness control signal generator for generating a brightness control signal which controls the first scan driving unit to control light emission brightness of each of the pixel circuits.

10. The OLED display of claim 9, wherein a voltage at the first node is adjusted by controlling a pulse width of the first scan signal from the first scan line in order to control a current supplied to the OLED.

11. The OLED display of claim 10, wherein the first scan driving unit generates a scan signal having a pulse width corresponding to the brightness control signal, and supplies the generated scan signal to the scan line.

12. The OLED display of claim 10, wherein the second transistor transfers a data signal from the data line to the second node in response to the first scan signal, the third transistor performs a diode-connection of the first transistor in response to the first scan signal from the first scan line, and the fourth transistor transfers a voltage of the first electric power to the second node in response to a light emission control signal from the light emission control line.

13. The organic light emitting apparatus of claim 12, wherein the pulse width of the first scan signal is smaller than the pulse width of the light emission control signal.

14. The organic light emitting apparatus of claim 12, further comprising:
a fifth transistor having a gate and a first electrode which are commonly connected to a second scan line and a second electrode connected to the first node; and
a sixth transistor having a gate connected to the light emission control line, wherein the sixth transistor is connected between the first transistor and the OLED,
wherein the fifth transistor initializes the first node in response to a second scan signal from the second scan line.

15. The OLED display of claim 14, wherein the first through sixth transistors are p-channel metal oxide semiconductor (PMOS) transistors.

16. A method of driving a pixel circuit of an organic light emitting diode (OLED) display having a first through sixth transistors, a storage capacitor, a data line, a scan line, and an OLED, the method comprising:
storing a data signal in the storage capacitor by applying the data signal via the data line to a first node through the second, first and third transistors, the first node being connected to a side of the storage capacitor, the first transistor being connected between a second node and the third transistor;
limiting a voltage of the stored data signal by controlling a pulse width of a first scan signal; and
applying an OLED current through the fourth and first transistors to the OLED according to the stored data signal by applying a light emission control signal to the fourth transistor, which is connected to a first electric power source and is connected in series with the first transistor, the first transistor being connected to the OLED.

17. The method of claim 16, further comprising:
initializing the first node of the pixel circuit before the storing the data signal in the storage capacitor by applying a second scan signal from a second scan line to a source and gate electrode of the fifth transistor having a drain electrode connected to the first node;
applying a first scan signal and a light emission control signal to turn off the second, third, fourth and sixth transistors concurrently with the initializing the first node; and
applying the second scan signal and the light emission control signal at a high level to the fourth, fifth and sixth transistors, in order to turn of the fourth, fifth and sixth transistors, concurrently with the storing the data signal in the storage capacitor.

18. The method of claim 17, wherein the applying the OLED current includes applying the OLED current through the sixth transistor to the OLED by applying the light emission control signal to the sixth transistor, which is disposed between the first transistor and the OLED,

19. The method of claim 16, wherein the current to the OLED is determined by the capacitor voltage at the first node.
